(19) United States
(12) Patent Application Publication
(10) Pub. No.: US 2018/0025553 A1
(43) Pub. Date: Jan. 25, 2018

(54) STEALTH MODE FOR VEHICLES

(71) Applicant: FORD GLOBAL TECHNOLOGIES, LLC, Dearborn, MI (US)

(72) Inventors: Manpreet Singh BAJWA, Novi, MI (US); Omar MAKKE, Lyon Township, MI (US); Perry Robinson MacNEILLE, Lathrup Village, MI (US); Oleg Yurievitch GUSIKHIN, West Bloomfield, MI (US)

(21) Appl. No.: 15/217,216

(22) Filed: Jul. 22, 2016

(51) Int. Cl. G07C 5/00; G06F 21/62; G06F 21/60; G07C 5/08

(52) U.S. Cl. CPC G07C 5/008; G07C 5/0825; G06F 21/6245; G06F 21/604

(57) ABSTRACT

A vehicle stores privacy settings that specify a plurality of data privacy protections to apply to vehicle communications over a network when the vehicle is in a stealth mode but not when the vehicle is in a normal mode. A telematics control unit of the vehicle indicates transition from the normal mode to the stealth mode responsive to connection of the vehicle to the network via an unknown service provider or responsive to vehicle entry to a predefined geofence area. The telematics control unit of the vehicle indicates transition from the stealth mode to the normal mode responsive to connection of the vehicle to the carrier to which the vehicle is subscribed for network service or vehicle exit from the geofence area.

### TECHNICAL FIELD

Aspects of the disclosure generally relate to adjusting data privacy setting modes for vehicles in communication over a network.

### BACKGROUND

Modern vehicles may include various telematics features, such as navigation, turn-by-turn directions, vehicle health reports, local business search, accident reporting, and hands-free calling. These features typically include one-way or two-way communication with remote servers, satellites, or other communication devices. For example, if an accident is detected, the vehicle telematics system may inform a call center. As another example, the vehicle telematics system may provide a current vehicle location to a remote server to aid in navigation through traffic.

### SUMMARY

In one or more illustrative embodiments, a system includes a memory of a vehicle storing privacy settings specifying a plurality of data privacy protections to apply to vehicle communications over a network when the vehicle is in a stealth mode but not when the vehicle is in a normal mode; and a telematics control unit of the vehicle configured to indicate transition from the normal mode to the stealth mode when connected to the network via an unknown service provider.

In one or more illustrative embodiments, a method includes using privacy settings specifying data privacy protections to apply to communications over a network when a vehicle is in stealth mode but not when the vehicle is in normal mode, transitioning a telematics control unit (TCU) of the vehicle from normal to stealth mode responsive to vehicle entry to a predefined geofence area; and transitioning the TCU from stealth to normal mode responsive to vehicle exit from the geofence area.

In one or more illustrative embodiments, a non-transitory computer-readable medium embodying instructions that, when executed by one or more processors of a vehicle controller, cause the controller to store privacy settings specifying a plurality of data privacy protections to apply to vehicle communications over a network when the vehicle is in a stealth mode but not when the vehicle is in a normal mode; transition a telematics control unit of the vehicle from the normal mode to the stealth mode responsive to vehicle entry to a predefined geofence area; transition the telematics control unit from the stealth mode to the normal mode responsive to vehicle exit from the geofence area; transition the telematics control unit from the normal mode to the stealth mode responsive to connection of the vehicle to the network via a service provider other than a carrier to which the vehicle is subscribed for network service; and transition the telematics control unit from the stealth mode to the normal mode responsive to connection of the vehicle to the carrier to which the vehicle is subscribed for network service.

### BRIEF DESCRIPTION OF THE DRAWINGS

FIG. 1 illustrates an example system for implementing stealth telematics modes in a vehicle;

FIG. 2 illustrates an example user interface of the vehicle for the configuration of the privacy settings of the vehicle;

FIG. 3 illustrates an example user interface of the vehicle for displaying a recommendation to change privacy modes of the vehicle; and

FIG. 4 illustrates an example process for the configuration of the privacy settings of the vehicle.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

With the increase in telematics and connected vehicle services, it may be desirable in some cases to reduce the information shared by the vehicle services. The reduction in information may be done, for example, to hide the location of the vehicle or the identity of the occupants of the vehicle with respect to communications between the vehicle and external systems. The reduction in information may prevent unauthorized access to the vehicle, and avoid identity theft or other intrusive practices which may cause inconvenience to the vehicle owner, driver, and/or occupants.

To perform the reduction, the telematics control unit of the vehicle may implement a stealth mode. In the stealth mode, the vehicle may perform operations such as to disable sharing of GPS and/or other vehicle parameters, disable broadcasting of user identity over browsers or other applications in communication with the vehicle, decline requests from outside entities to the vehicle, notify users to turn off their smartphones, disable the telematics control unit from transmitting data, and/or disable one or more of DSRC communication, WiFi, BLUETOOTH, or other wireless signals. The telematics control unit may perform the operations to enter stealth mode based on criteria including the location of the vehicle or the network to which the telematics control unit of the vehicle is connected. Further aspects are described in detail below.

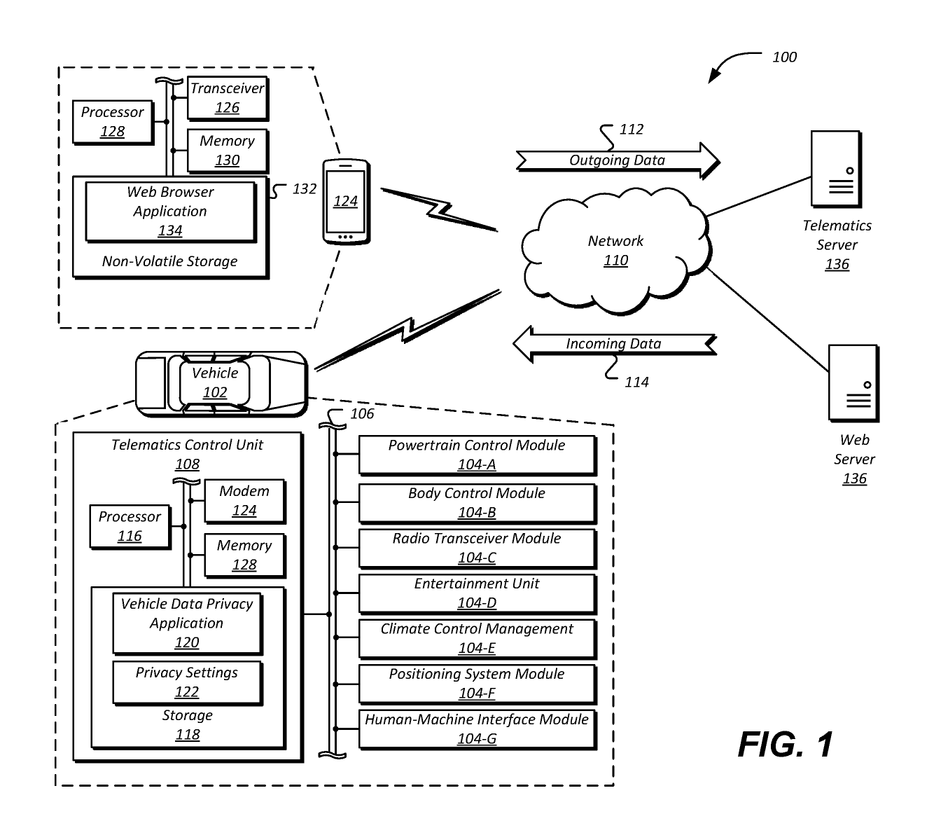

FIG. 1 illustrates an example system 100 for implementing stealth telematics modes in a vehicle 102. The system 100 includes a vehicle 102 having a plurality of electronic control units (ECUs) 104 in communication with one another and with a telematics control unit (TCU) 108 over one or more vehicle buses 106. The vehicle 102 may additionally be in communication with one or more servers 136 (e.g., telematics servers 136, web servers 136, etc.) over the network 110. While an example system 100 is shown in FIG. 1, the example components as illustrated are not intended to be limiting. Indeed, the system 100 may have more or fewer components, and additional or alternative components and/or implementations may be used.

The vehicle 102 may include various types of automobile, crossover utility vehicle (CUV), sport utility vehicle (SUV), truck, recreational vehicle (RV), boat, plane, or other mobile machine for transporting people or goods. In many cases, the vehicle 102 may be powered by an internal combustion engine. As another possibility, the vehicle 102 may be a hybrid electric vehicle (HEV) powered by both an internal combustion engine and one or more electric motors, such as a series hybrid electric vehicle (SHEV), a parallel hybrid electric vehicle (PHEV), or a parallel/series hybrid electric vehicle (PSHEV). As the type and configuration of vehicle 102 may vary, the capabilities of the vehicle 102 may correspondingly vary. As some other possibilities, vehicle 102 may have different capabilities with respect to passenger capacity, towing ability and capacity, and storage volume.

The vehicle 102 may include a plurality of ECUs 104 configured to perform and manage various vehicle 102 functions under the power of the vehicle battery and/or drivetrain. The ECUs 104 may be computing devices including hardware processors configured to execute software and/or firmware to perform the operations of the ECUs 104 discussed herein. As depicted in the illustrated example, the vehicle ECUs 104 are represented as discrete ECUs 104-A through 104-G. However, the vehicle ECUs 104 may share physical hardware, firmware, and/or software, such that the functionality from multiple ECUs 104 may be integrated into a single ECU 104, and the functionality of various such ECUs 104 may be distributed across a plurality of ECUs 104.

As some non-limiting vehicle ECUs 104 examples: a powertrain control ECU 104-A may be configured to provide control of engine operating components; a body control ECU 104-B may be configured to manage various power control functions such as exterior lighting, interior lighting, keyless entry, remote start, and point of access status verification; a radio transceiver ECU 104-C may be configured to communicate with key fobs, mobile devices, or other local vehicle 102 devices; an entertainment control unit 104-D may be configured to support voice command and BLUETOOTH interfaces with the driver and driver carry-on devices; a climate control management ECU 104-E may be configured to provide control of heating and cooling system components (e.g., compressor clutch, blower fan, temperature sensors, etc.) to manage climate in cargo and/or passenger compartments; and a global positioning system (GPS) ECU 104-F may be configured to provide vehicle location information; and a human-machine interface (HMI) ECU 104-G may be configured to receive user input via various buttons or other controls, as well as provide vehicle status information to a driver or other vehicle 102 occupants.

The vehicle bus 106 may include various methods of communication available between the vehicle ECUs 104, as well as between the TCU 108 and the vehicle ECUs 104. As some non-limiting examples, the vehicle bus 106 may include one or more of a vehicle controller area network (CAN), an Ethernet network, and a media oriented system transfer (MOST) network.

The TCU 108 may include a cellular modem or other network hardware configured to facilitate communication over the communications network 110 between the vehicle 102 and other devices of the system 100. The network 110 may include one or more interconnected communication networks such as the Internet, a cable television distribution network, a satellite link network, a local area network, a wide area network, and a telephone network, as some non-limiting examples. Using the TCU 108, the vehicle 102 may be able to send outgoing data 112 from the vehicle 102 to network destinations on the network 110, and receive incoming data 114 to the vehicle 102 from network destinations on the network 110.

The TCU 108 may further include various types of computing apparatus to facilitate the performance of the telematics functions. In an example, the TCU 108 may include one or more processors 116 configured to execute computer instructions, and a storage medium 118 on which the computer-executable instructions may be maintained. A computer-readable storage medium 118 (also referred to as a processor-readable medium 118 or storage 118) includes any non-transitory (e.g., tangible) medium that participates in providing data (e.g., instructions) that may be read by a computer (e.g., by the processor(s) 116). In general, a processor 116 receives instructions, e.g., from the storage 118, etc., and executes these instructions, thereby performing one or more processes, including one or more of the processes described herein. Computer-executable instructions may be compiled or interpreted from computer programs created using a variety of programming languages and/or technologies, including, without limitation, and either alone or in combination, Java, C, C++, C#, Fortran, Pascal, Visual Basic, Python, Java Script, Perl, PL/SQL, etc.

The telematics privacy application 120 may be one application included on the storage 118 of the TCU 108. The telematics privacy application 120 may include instructions that, when executed by the processor 116 of the TCU 108, cause the TCU 108 to manage data privacy aspects with relation to the ECUs 104 or other vehicle 102 components via the vehicle bus 106. As explained in greater detail below, the telematics privacy application 120 may be configured to apply the privacy settings 122 stored to the storage 118 to the communications of the vehicle 102 via the TCU 108 (e.g., the outgoing telematics data 112 and incoming telematics data 114).

Various communications of the vehicle 102 over the network 110 via the TCU 108 may implicate data privacy aspects, including the communications of the vehicle 102 with other vehicles 102, with telematics services external to the vehicle 102, or with other third-party servers external to the vehicles 102. For instance, in some cases the vehicle 102 occupants may prefer that data such as location information from the positioning system module 104-F or other vehicle parameters not be shared via the TCU 108. As another possibility, vehicle 102 occupants may have preferences that broadcasting of user identity over browsers or other applications not be performed using the TCU 108 network services. As a further possibility, vehicle 102 occupants may have preferences that browser fingerprinting or device fingerprinting information be obfuscated or omitted. Information to create the fingerprint that may be obfuscated may include, as some non-limiting possibilities, user agent, accept header information, content encoding, content language, available plugins, platform, screen resolution, and installed fonts. In another possibility, vehicle 102 occupants may have preferences with respect to whether requests from external servers or other devices to the vehicle 102 from outside entities to the TCU 108 may be allowed.

The privacy settings 122 may specify modes of operation for the TCU 108 and/or other ECUs 104 of the vehicle 102 with respect to data privacy. These modes may include a normal mode in which communications are unrestricted, a stealth mode in which certain communications settings are restricted, and a disable mode in which substantially all communications via the TCU 108 are disabled.

For instance, in the normal mode, vehicle parameters may be transmitted by the TCU 108, user identity may be broadcasted by web browsers accessing the network 110 via the TCU 108, and network requests from external devices may be allowed by the TCU 108.

In the stealth mode, however, certain vehicle parameters such as location information or vehicle identifiers (e.g., VIN, etc.) may be disabled from transmission via the TCU 108, user identity information may be restricted from being broadcast from the TCU 108, and network requests from external devices may be denied by the TCU 108. For communications that are not made through the TCU 108, e.g., those made by a user's mobile device 124, the stealth mode may specify for the vehicle 102 to notify the user using the HMI module 104-G to turn off their mobile device 124 (e.g., via a display or voice prompt). As some further examples of stealth mode tactics, when in stealth mode the TCU 108 may automatically turn on and off “airplane” mode when needed to avoid idle connections, automatically turn on and off a data plan when needed to avoid idle connection to cellular, periodically switching WiFi and BLUETOOTH MAC addresses, only using location services when needed, use of virtual private network (VPN) or Tor service anonymization, dithering GPS location, periodically clearing cookies, dithering transmission power of the mobile device, and use of directional antennas.

In the disabled mode, substantially all transmissions from the TCU 108 may be disabled. Additionally or alternately, in the disabled mode, DSRC, WiFi, BLUETOOTH, or other wireless communications of the vehicle 102 may also be disabled.

The vehicle ECUs 104 of the vehicle 102 may provide for or support telematics services of the vehicle 102. These ECUs 104 may be configured to operate in the various operational modes under the direction of the telematics privacy application 120, such that in each mode, the data privacy behavior of the vehicle ECUs 104 may be performed in accordance with the requirements for the different modes. In an example, the telematics privacy application 120 may cause the TCU 108 to provide a message to the other vehicle ECUs 104 over the vehicle bus 106 specifying the current privacy settings 122 mode of the vehicle 102. Responsive to that message, the vehicle ECUs 104 may configure their functions accordingly. For instance, the positioning system 104-F may deny requests for location information, or may add randomness to the located vehicle 102 position responsive to the current privacy settings 122. Or, the HMI module 104-G may provide a notification to the user indicating the current privacy settings 122 mode of the vehicle 102 responsive to receipt of a message indicating update of the current privacy settings 122 mode.

The mobile devices 124 may be any of various types of portable computing devices, such as cellular phones, tablet computers, smart watches, laptop computers, portable music players, or other devices capable of communication over the communications network 110. In an example, the mobile devices 124 may communicate with the communication network 110 via a wireless transceiver 126 of the mobile device 124. Similar to the TCU 108, the mobile devices 124 may include one or more processors 128 configured to execute instructions of mobile applications loaded to a memory 130 of the mobile device 124 from storage medium 132 of the mobile device 124. A web browser application 134 may be an example of a mobile application installed to the mobile device 124.

When the mobile device 124 is connected to the vehicle 102, the web browser application 134 may utilize the services of the TCU 108 to connect to the network 110. Thus, when connected to the vehicle 102, the web browser application 134 may be affected by the current privacy settings 122 mode of the TCU 108. For instance, when in the stealth mode, the TCU 108 may strip privacy-sensitive information from HTTP headers of web browser application 134 communications via the TCU 108.

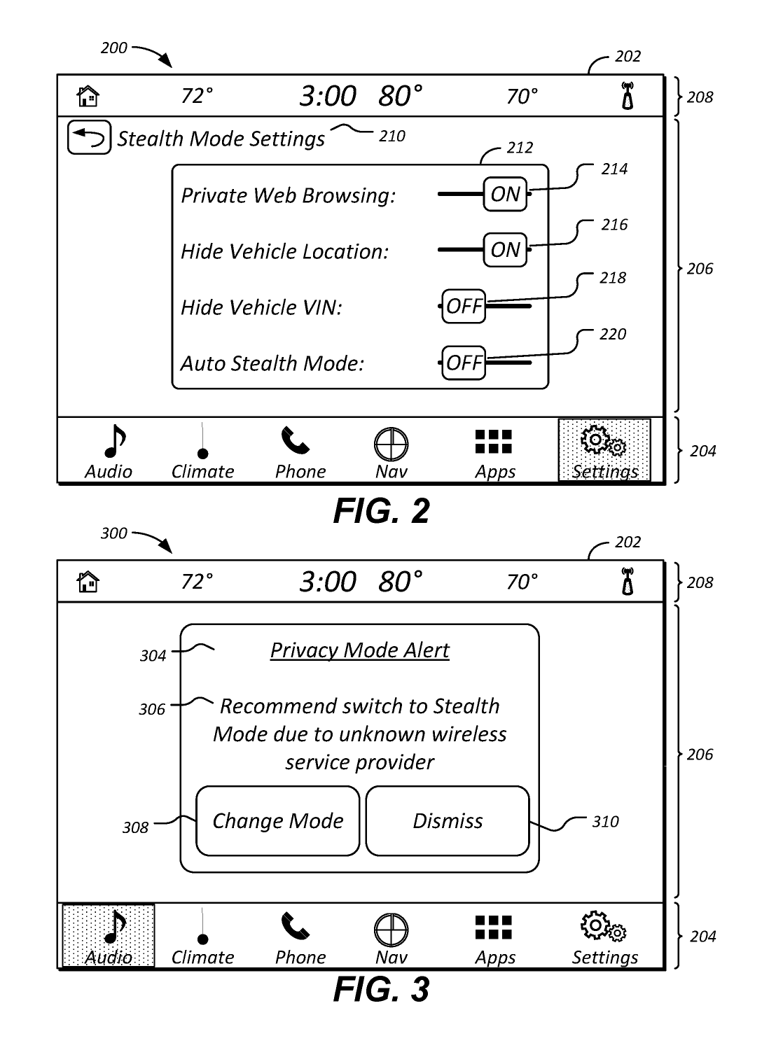

FIG. 2 illustrates an example user interface 200 of the vehicle 102 for configuration of the privacy settings 122 of the vehicle 102. In an example, the user interface 200 may be displayed on a head unit or other display 202 of the vehicle 102. The head unit display 202 may be driven, for example, by a video connection of a video controller of the HMI module 104-G in communication over the vehicle bus 106 with the TCU 108. The user interface 200 may allow the user to configure the privacy settings 122 of the TCU 108 regarding what data privacy functions to invoke in stealth mode. In some examples, the user interface 200 may be displayed responsive to user selection of a data privacy configuration option in the HMI of the vehicle 102. To facilitate the configuration of the TCU 108, driver selections made to the user interface 200 may be provided to the telematics privacy application 120 of the TCU 108 over the vehicle bus 106, which in turn may update the privacy settings 122 maintained to the storage 118 of the TCU 108.

As shown, the user interface 200 includes a category listing 204 of one or more screen of content to be displayed in the main screen area 206 of the head unit display 202. As some examples, the category listing 204 may include an audio screen from which configuration of vehicle 102 audio settings may be performed, a climate control screen from which vehicle 102 climate control settings may be configured, a phone screen from which calling services may be utilized, a navigation screen from which maps and routing may be performed, an applications screen from which installed applications may be invoked, and a settings screen from which backlighting or other general settings of the head unit display 202 may be accessed. The user interface 200 may also include a general information area 208 from which time, current temperature, and other information may remain visible to the user, regardless of the specific screen or application that is active in the main screen area 206.

In the main screen area 206, the user interface 200 may include a description label 210 indicating that the user interface 200 is for configuration of the stealth mode privacy settings 122 of the TCU 108. The main screen area 206 also includes a configuration panel 212 including the configurable options. These stealth mode options may include, for example, a private web browsing option 214 allowing the driver to select whether to enable or disable private web browsing for TCU 108 web traffic during stealth mode, a hide vehicle location option 216 allowing the driver to select whether vehicle GPS, postal code, or other location information should be removed from outgoing data 112 during stealth mode, a hide vehicle VIN option 218 allowing the driver to select whether identifiers of the vehicle 102 should be removed from outgoing data 112 during stealth mode; and an automatic stealth mode option 220 that allows the user to toggle whether stealth mode is applied automatically or instead the user is prompted to make a mode change. It should be noted that these configurable options are merely examples, and more, fewer, different, and/or differently ordered options may be used.

FIG. 3 illustrates an example user interface 300 of the vehicle 102 for displaying a recommendation 302 to change privacy modes of the vehicle 102. The recommendation 302 may be displayed responsive to receipt by the HMI module 104-G over the vehicle bus 106 of a message from the TCU 108 recommending a change in the privacy mode. As shown, the recommendation 302 includes a title 304 to indicate to the driver that the recommendation 302 is generated from the telematics privacy application 120 of the TCU 108. The recommendation 302 may further include a description label 306 describing the recommended change in mode (e.g., that stealth mode is recommended due to connection of the TCU 108 to an unknown network service provider). The recommendation 302 may also include a change mode button 308 that, when selected by the driver, is configured to cause the telematics privacy application 120 of the TCU 108 to receive permission to apply the suggested mode to the vehicle 102. The recommendation 302 may also include a dismiss button 310 that, when selected by the driver, is configured to dismiss the recommendation 302 without adjusting the privacy mode.

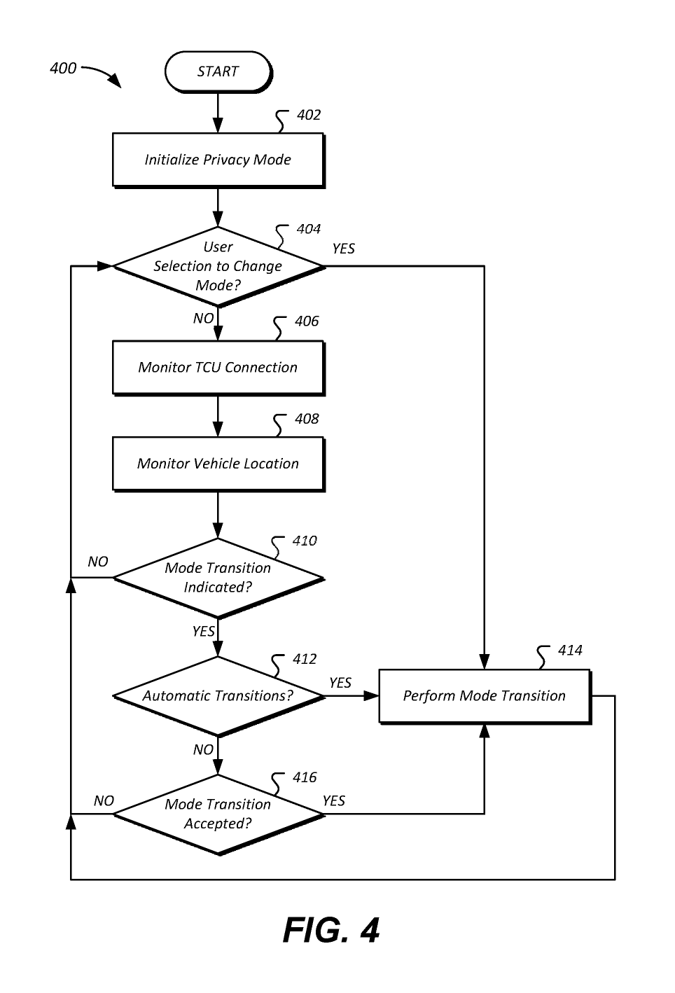

FIG. 4 illustrates an example process 400 for the configuration of the privacy settings 122 of the vehicle 102. In an example, the process 400 may be performed by the TCU 108 executing the telematics privacy application 120.

At operation 402, the TCU 108 initializes the privacy mode of the vehicle 102. In an example, upon vehicle 102 startup, the TCU 108 may initialize the vehicle 102 privacy mode to the normal mode of the privacy settings 122. In another example, the vehicle 102 may store the current privacy mode upon key off, and may return to the previously saved privacy mode when the TCU 108 is restarted.

At operation 404, the TCU 108 determines whether a user selection of a change to the privacy mode of the vehicle 102 is received. In an example, the user may input to the vehicle 102 an explicit request to change the privacy mode. For instance, the user may select an option from the vehicle 102 HMI to transition from the normal mode to the stealth mode, or from the stealth mode to the normal mode. The user input may be transmitted from the HMI module 104-G to the TCU 108 over the vehicle bus 106. If a user selection input is received to the TCU 108, control passes to operation 414. Otherwise, control passes to operation 406.

At operation 406, the TCU 108 monitors the TCU connection to the network 110. In an example, the TCU 108 may maintain a cellular data connection to the network 110. This data connection may be provided over a carrier through which the TCU 108 is subscribed for service, or in other cases by another carrier with a peering agreement or other agreement with the subscribed carrier.

At operation 408, the TCU 108 monitors the location of the vehicle 102. In an example, the TCU 108 may utilize the positioning system module 104-F of the vehicle 102 to obtain GPS coordinates of the current location of the vehicle 102 via the vehicle bus 106.

At operation 410, the TCU 108 determines whether a privacy mode transition is indicated based on the monitoring. In an example, the TCU 108 may determine, based on the identity of the carrier currently connected to the TCU 108, to transition the privacy mode. For instance, the TCU 108 may determine to transition from the normal mode to the stealth mode when the TCU 108 becomes connected to a service provider other than the carrier through which the TCU 108 is subscribed for service, and to the normal mode when the TCU 108 is again connected to the carrier through which the TCU 108 is subscribed for service. In another example, the TCU 108 may determine, based on the physical location of the vehicle 102 being within a geofence or other predefined area in which stealth mode is set, to transition to the stealth mode, and when not in such an area to transition to the normal mode. The specific geofences may be set by the user via the vehicle 102 HMI, or in other cases may be received by the TCU 108 over the network 110 from the telematics server 136. If a privacy transition is indicated, control passes to operation 412. Otherwise, control passes to operation 404.

At operation 412, the TCU 108 determines whether automatic privacy mode transitions are enabled. In an example, the TCU 108 may access the privacy settings 122 to determine whether automatic stealth mode is activated. If so, control passes to operation 416. If not, control passes to operation 414 to provide a recommendation 302 to the user.

At operation 414, the TCU 108 displays a recommendation 302 to the user indicating the privacy mode that is recommended for the vehicle 102. The recommendation 302 may be displayed responsive to receipt by the HMI module 104-G over the vehicle bus 106 of a message from the TCU 108 recommending a change in the privacy mode. An example of the recommendation 302 is discussed above with respect to FIG. 3. If the user selects the change mode button 308, control passes to operation 416 to perform the privacy mode transition. If not, or if the user selects the dismiss button 310, control passes to operation 404 and no change in the privacy mode is performed.

At operation 416, the TCU 108 performs the privacy mode transition. In an example, the TCU 108 may apply the privacy settings 122 for the updated mode to the communications that are made through the TCU 108. In another example, the TCU 108 may provide a message to the other vehicle ECUs 104 over the vehicle bus 106 specifying the current privacy settings 122 mode of the vehicle 102. Responsive to that message, the vehicle ECUs 104 may configure their functions accordingly. For instance, the positioning system 104-F may deny requests for location information, or may add randomness to the located vehicle 102 position responsive to the current privacy settings 122. Or, the HMI module 104-G may provide a notification to the user indicating the current privacy settings 122 mode of the vehicle 102 responsive to receipt of a message indicating update of the current privacy settings 122 mode. In yet another example, for communications that are not controllable via the TCU 108, the TCU 108 may notify the user using the HMI module 104-G to turn off their mobile device 124 (e.g., via a display or voice prompt). After operation 416, control passes to operation 404.

Computing devices described herein, such as the ECUs 104, TCU 108, and mobile device 124 generally include computer-executable instructions where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, C#, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a memory storing privacy settings specifying a plurality of data privacy protections to apply to vehicle communications over a network when the vehicle is in a stealth mode but not when the vehicle is in a normal mode; and
a telematics control unit of the vehicle configured to indicate transition from the normal mode to the stealth mode responsive to connection of the vehicle to the network via an unknown service provider.

2. The system of claim 1, wherein the telematics control unit is further configured automatically apply the data privacy protections responsive to the transition to the stealth mode.

3. The system of claim 1, wherein the telematics control unit is further configured to automatically cause a display of a recommendation in a vehicle human-machine interface requesting the transition from the normal mode to the stealth mode responsive to the indication of the transition to the stealth mode.

4. The system of claim 1, wherein the telematics control unit is further configured to send a privacy settings update mode message over a vehicle bus to indicate to electronic control units of the vehicle to transition to the stealth mode.

5. The system of claim 1, wherein the telematics control unit is further configured to cause a display of a recommendation in a vehicle human-machine interface requesting that the user manually disconnect mobile devices from the network responsive to transitioning from the normal mode to the stealth mode.

6. The system of claim 1, wherein the data privacy protections include removing user identity information from web headers provided by the telematics control unit.

7. The system of claim 1, wherein the data privacy protections include removing information indicating a current location of the vehicle from the communications provided by the telematics control unit.

8. The system of claim 1, wherein the data privacy protections include denying incoming requests to the telematics control unit.

9. A method comprising:
using privacy settings specifying data privacy protections to apply to communications over a network when a vehicle is in stealth mode but not when the vehicle is in normal mode, transitioning a telematics control unit (TCU) of the vehicle from normal to stealth mode responsive to vehicle entry to a predefined geofence area; and
transitioning the TCU from stealth to normal mode responsive to vehicle exit from the geofence area.

10. The method of claim 9, further comprising transitioning the TCU from normal to stealth mode responsive to connection of the vehicle to the network via a service provider other than a carrier to which the vehicle is subscribed for network service.

11. The method of claim 10, further comprising transitioning the TCU from stealth to normal mode responsive to connection of the vehicle to the carrier to which the vehicle is subscribed for network service.

12. The method of claim 9, further comprising indicating the transition from normal to stealth mode in a vehicle human-machine interface.

13. The method of claim 9, further comprising sending a privacy settings update mode message over a vehicle bus indicating to electronic control units of the vehicle to transition to the stealth mode.

14. A non-transitory computer-readable medium embodying instructions that, when executed by one or more processors of a vehicle controller, cause the controller to:
store privacy settings specifying a plurality of data privacy protections to apply to vehicle communications over a network when the vehicle is in a stealth mode but not when the vehicle is in a normal mode;
transition a telematics control unit of the vehicle from the normal mode to the stealth mode responsive to vehicle entry to a predefined geofence area;
transition the telematics control unit from the stealth mode to the normal mode responsive to vehicle exit from the geofence area;
transition the telematics control unit from the normal mode to the stealth mode responsive to connection of the vehicle to the network via a service provider other than a carrier to which the vehicle is subscribed for network service; and
transition the telematics control unit from the stealth mode to the normal mode responsive to connection of the vehicle to the carrier to which the vehicle is subscribed for network service.

15. The medium of claim 14, wherein the data privacy protections include removing user identity information from web headers provided by the telematics control unit.

16. The medium of claim 14, wherein the data privacy protections include removing information indicating a current location of the vehicle from the communications provided by the telematics control unit.

17. The medium of claim 14, wherein the data privacy protections include denying incoming requests to the telematics control unit.
